(19) United States
(12) Patent Application Publication
(10) Pub. No.: US 2013/0300180 A1
(43) Pub. Date: Nov. 14, 2013

(54) Dump gate to fit front end loader

(71) Applicant: Tony Lee Graves, Taos, NM (US)

(72) Inventor: Tony Lee Graves, Taos, NM (US)

(21) Appl. No.: 13/506,685

(22) Filed: May 8, 2012

(51) Int. Cl. B60P 1/267

(52) U.S. Cl. 298/23 MD

(57) ABSTRACT

Disclosed is a dump gate comprised of a three sided metal frame with pivot points attached to the lowest point of the existing bucket's frame on the outside with appropriate hardware. The front side of the dump gate has a proper angled blade that closes the dump gate and contacts the front side of the lower portion of the existing bucket less a safety gap. When the bucket is used to collect engineered material the dump gate raises to allow the bucket to receive its contents. When the bucket is lowered the dump gate drops to the allowed opening that is restricted by its controlling chain and the contents is released in a metered amount allowing both quality and quantity of the contents to be released. The dump gate reduces the need for additional manual labor usually used to control quality and quantity.

### BACKGROUND OF THE INVENTION

1. Field of Invention

The present invention relates to an attachment which when added to an existing modified tractor bucket, or in a custom bucket/Dump Gate combination, allows for measured spreading of the bucket contents in a consistent manner. The dump gate does not require any power supply. If the dump gate is used with an existing tractor bucket, the bucket must be modified by a competent welder or manufacture approved provider.

2. Description of Prior Art

Filling of holes or trenches during new construction or re-modeling construction provides challenges in proper replacement of fill matter on venerable service items such as water supply piping or electrical wiring. Boulders and other similar objects can penetrate service items being buried and require repair or replacement at additional expense and delay of completion. This process is time consuming and poses a significant impediment of construction completion. Typically, one or more workers walk along the open trench and are exposed to dangers from the construction equipment as well as the open trench. Metering of engineered fill, also known as ground coverage material, gravel, engineered material, aggregate or dirt, is complicated by the current inability of the tractor's bucket to control the release of its contents. Conventional methods of correcting for this are the use of manual laborers workers, to move and align piles of ground coverage with shovels or similar tools. This process is time consuming and poses additional expense in the form of manual labor payroll as well as safety hazards. Typically, one or more workers walk along the tractor removing or spreading contents in or around open ditches: or other uneven surfaces.

U.S. Pat. No. 4,449,648 describes a mobile spreader unit comprises a tractor and a detachable hopper. The latter is defined by tapering front and rear walls and has a breadth permitting it to fit in between the rear wheels of the tractor. There is an elongate spreader opening in the bottom of the hopper, and an agitator adjacent to the mechanism driven by a roller to be brought into contact with one of the rear wheels of the tractor. Pivots at the front wall of the hopper are attachable to brackets at the tractor, and are located so the point of gravity of the hopper tends to tilt it away from the tractor. In its furthermost tilted position the rear wall will be substantially parallel to the ground, and the hopper may then be used to scoop up particulate material to be spread. A pressure fluid actuator raises the hopper to an upright position, in which finally the roller contacts the rear wheel of the tractor and drives the agitator.

This equipment is limited to operation on the back of a tractor. It uses a powered hopper to spread material without the ability to control the release.

U.S. Pat. No. 4,080,911 describes the present invention relates to a fertilizer distributor attachment that is adapted to be mounted to a conventional transplanter and powered thereby through a frictional drive system that includes a friction drive wheel associated with said fertilizer distributor attachment and engageable with a furrow closing wheel assembly rotatively mounted to the transplanter and which engages the ground as the transplanter traverses a field during the transplanting operation.

This equipment is limited to a fertilizer distributor and is not designed to release engineered material. Furthermore the equipment restricted to being attached to a conventional transplanter.

U.S. Pat. No. 6,929,329 A dump trailer gate for trucks having a gate door movably positioned within a dump door opening of a dump door. A first lever is securely attached to the gate door extending downwardly therefrom. When a front end of a scoop of a bucket loader applies pressure onto the first lever, the gate door opens and contents of the dump truck spill into the scoop. A second lever is securely attached to an opposite side of the gate door extending outwardly therefrom. At least one biasing spring is attached at a bottom distal end to the second lever and attached at a top distal end to the dump door. When pressure is released from the first lever, the gate door automatically closes.

This equipment is limited to dump trucks. Additionally this is not designed to be a controlled release of metered material in confined areas.

U.S. Pat. No. 6,499,808 describes a dump vehicle with a positively controlled opening gate is disclosed. The vehicle includes a frame, a dump bed mounted on the frame and having a floor, front and side walls and a rear opening through which material can be discharged from the bed, and a gate having a pair of lateral edges and a lower edge. The gate is pivotally mounted adjacent the rear opening and has a closed position in which the gate blocks the rear opening to prevent discharge from the bed through the rear opening. The vehicle further includes a gate control mechanism connected to the gate. The gate control mechanism is adapted to selectively raise the gate from the closed position to allow metered discharge of material or to release the gate from the closed position so that the gate may pivot away from the rear opening to allow unmetered discharge of material

This equipment is limited to a truck dump bed and not a tractor bucket. Additionally this is not designed to a controlled release of metered material in a confined area.

### SUMMARY OF THE INVENTION

The present invention is a device which is attached to an existing tractor bucket or incorporated into a new bucket which is designed to fit around the outside front left and right side of the bucket frame at its opening. The sides of the device are secured to the outside base of the curvature of the bucket via removable bolt and nuts or similar attachment devises that are inserted in their corresponding connection point in the device's arms at a lower point of the circumference of the bucket. The blade of the device is of sufficient length and proportional to the size of the bucket. The blade of the Dump Gate is angled at a 45 degree angle downward and inward from the head of the device toward the pivot points in the arm's extensions. The top of the blade has a restraining chain or similar object that is available to be adjusted to the appropriate length via a connection point either permanently or temporarily attached to the top center open side of the bucket.

It is therefore a primary object of the present invention to provide a scalable dump gate that is manually adjustable by the user to various calculated openings therefore providing a metered release of material.

It is another object of the present invention to provide a convenient and cost effective way to spread engineered material with minimal worker intervention and at a significant savings.

It is a further object of the present invention to provide a Dump Gate which can be easily be adopted to use with various types of tractors, loaders telehandlers utility vehicles and other similar vehicles intended for this purpose.

It is still further object of the present invention to provide a Dump Gate which can be operated by one person using one piece of equipment and operated safely which would reduce human exposure to potentially dangerous situations.

These and other objects of the present invention, will become apparent to those skilled in this art upon reading the accompanying description, drawing, and claims set forth herein.

### BRIEF DESCRIPTION OF THE DRAWINGS

FIG. 1 is a front view of the Dump Gate according to the present invention.

FIG. 2 is the side view of the Dump Gate of the present invention.

FIG. 3 is the top view of the Dump Gate of the present invention.

FIG. 4a is the expanded view of the connection point of the present invention.

FIG. 4b is the expanded view of the connection point for adjusting of Dump Gate's opening to the existing bucket.

FIG. 5 Side view of the Dump Gate showing the attach points of the side arms and retaining clip.

### DETAILED DESCRIPTION OF THE INVENTION

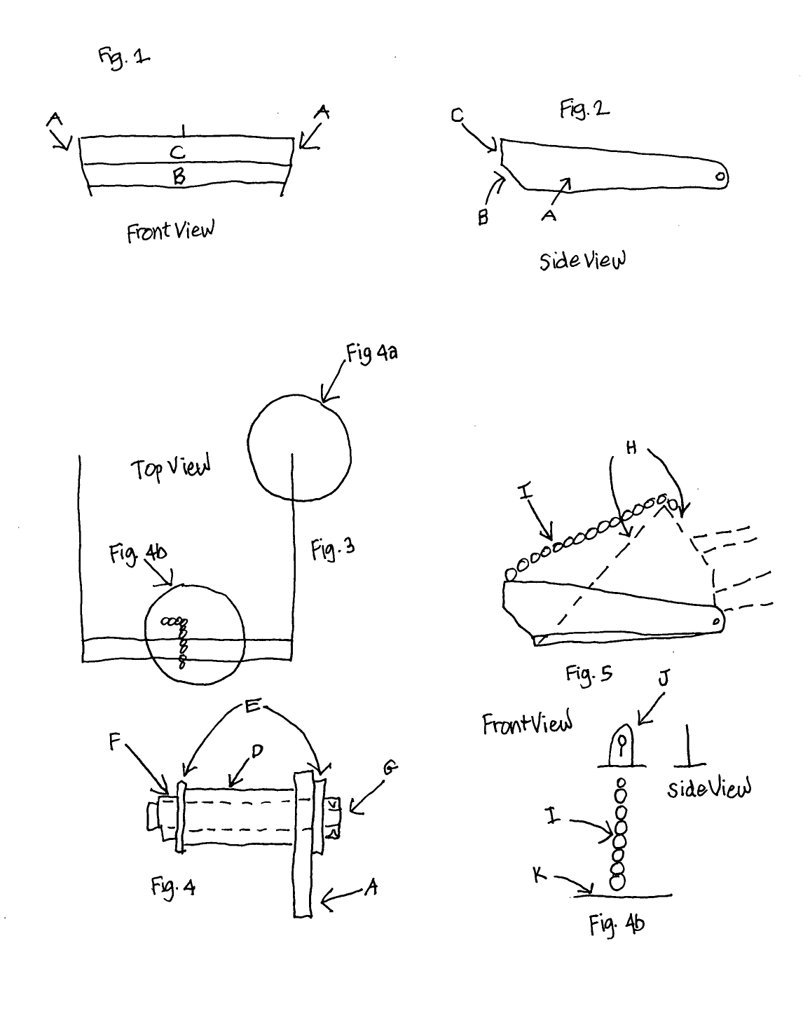

FIG. 1 shows the front view of the best mode contemplated by the inventor of the Dump Gate according to the concepts of the present invention. As can be amply seen from the drawings the Dump Gate is variable in length to accommodate the bucket size of which it is attached to. The Dump Gate can be equipped or sized to accommodate various sizes of buckets and manufactures makes and models.

### A) Side arm of the Dump Gate.

B) The angled blade of the Dump Gate.
C) The front plate of the Dump Gate.

FIG. 2 shows the side view of the best mode contemplated by the inventor of the Dump

Gate according to the concepts of the present invention. As can be amply seen from the drawings. the Dump Gate is variable in length to accommodate the bucket size length of which it is attached to.

### A) Side arm of the Dump Gate.

B) The angled blade of the Dump Gate.
C) The front plate of the Dump Gate.

FIG. 3 shows the top view of the Dump Gate of the best mode contemplated by the inventor of the Dump Gate according to the concepts of the present invention. As can be amply seen from the drawings the Dump Gate is variable in length to accommodate the bucket size length of which it is attached to.

FIG. 4a shows the enlarged view of the connection point of the Dump Gate and the cylindered connection (D) attached to the existing bucket including the appropriate washers (E) and retaining nut (F) and bolt (G).

### A) Side arm of the Dump Gate.

D) Connection point of the Dump Gate.

### E) Washer(s)

F) Nut attached to the bolt holding the Dump Gate to the bucket.
G) Bolt for attaching to Dump Gate existing bucket.

FIG. 4b shows the enlarged view of the Dump Gate retaining chain (I) attached to the Dump Gate (K) and retaining clip (J) attached to the existing bucket.

I) Restricting chain for limiting Dump Gate opening for release of material.
J) Retaining clip attached to the top center of existing bucket configured to hold the restricting chain.
K) Restricting chain contact point attached to the top center of the Dump Gate.

FIG. 5 shows the sideview of the present invention attached to an existing bucket showing the connection points of the side arms and the restraining chain and appropriate connection retaining clip.

H) Existing bucket.
I) Adjustable restraining chain for limiting Dump Gate opening for release of material.

The Dump Gate will carry out its tasks in the following sequence. The operator of the front end loader with the Dump Gate attached through the use of the hydraulic controls in the cab lowers the bucket to ground level to acquire material. As the vehicle approaches the material the loader bucket fills with material at the same time the Dump Gate separates from its resting position lifting under the pressure of the material entering the bucket letting the material enter without restriction. When an appropriate amount of material is acquired the operator using the front end loader controls for the lift arms and bucket, rotates the bucket allowing for the Dump Gate to close to its original position.

The Dump Gate will carry out its task in the following sequence. Upon reaching the desired location the operator using the combination of controls rotates the bucket to the appropriate downward angle to release the material from the opening between the bucket frame and the predetermined Dump Gate opening.

What is claimed is:

1. A Dump Gate comprising; a three sided unit that does not require a power source; that attaches at a pivot point appropriate to the size; via attachment points that allow pivoting with the lower blade portion on the Dump Gate recessed at an angle of approximately 45 degrees; corresponding left and right arms with a restraining chain; cable or similar item attached at the center top of the bucket; secured to the corresponding top connection point of the existing bucket; with the Dump Gate attached through the use of the hydraulic controls in the operator lowers the bucket to ground level to acquire material; as the vehicle approaches the material the loader bucket fills with material at the same time the Dump Gate separates from its resting position lifting under the pressure of the material entering the bucket letting the material enter without restriction; when the appropriate amount of material is acquired the operator using the front end loader controls for the lift arms and bucket, rotates the bucket allowing for the Dump Gate to close to its original position.

2. The Dump Gate according to claim 1 wherein includes a means for altering the length and width and depth of the unit as well as its ability to provide a measured release of material via the opening created by the distance between the bottom bucket blade and the Dump Gate.

3. The Dump Gate according to claim 1, wherein the front edge of the Dump Gate and the corresponding angled blade is calculated to when the bucket is acquiring material in the collection mode the dump gate floats up without human intervention or an external power source therefore allowing material to be gathered in the bucket without loss of capacity.

4. The Dump Gate according to claim 1 the operator upon reaching their destination can through the use of the front loader controls and the previously adjusted Dump Gate opening disburse the material in a controlled manner as needed or directed.

5. Dump gate according, to claim 1, is capable of controlling the quantity of release.

6. The Dump Gate according to claim 1 is capable of restricting release of undesired material by virtue of the gate's opening therefore limiting damage to trenched material.

7. The Dump Gate according to claim 1 provides for increased productivity and safety by allowing the tractor driver to collect and disperse engineered material without the need to additional personnel on the ground.

8. The Dump Gate according to claim 1 is a non-powered add on to existing or new tractor bucket accessory.

9. The Dump Gate according to claim 1 after installation of connection points the Dump Gate may be removed by personnel with common knowledge without specialized tools.

10. The Dump Gate according to claim 1 allows for the gate opening to be adjusted to various openings to meet user's needs.

11. The Dump Gate according to claim 1 can be attached to different manufactures existing buckets according to size.

12. The Dump Gate according to claim 1 is simple and easy to use.

13. The Dump Gate according to claim 1 does not need additional maintenance after installation

14. The Dump Gate according to claim 1 does not need alignment adjustments after installation.

15. The Dump Gate according to claim 1 the angle of the front blade is preset to allow upward movement therefore allowing gathered material to enter without further assistance.

16. The Dump Gate according to claim 1 retains material in the bucket until operator is ready to release at the designated area.

17. The Dump Gate according to claim 1 the dump gate will move out of the buckets bottom blade without assistance or external power source

18. The Dump Gate according to claim 1 increases safety by eliminating the need for additional personnel to be present around open trenches and ditches.

19. The Dump Gate according to claim 1 is designed to increase productivity in the field of use.

20. A Dump Gate comprising:
An existing tractor or similar construction vehicle with a bucket with the Dump Gate previously attached comprising the following steps;
at the outside lower most curvature of the existing bucket a competent welder or vehicle maintenance person attaches a connection point (FIG. 4a-D) by welding to each side of the existing bucket;
a bolt washer(s)and nut (FIG. 4a-G, E &F) secure the arms of the Dump Gate(FIG 4a-A) to the outside of the existing bucket;
a restraining plate (FIG. 4b-J) is attached to the top center of the existing bucket and welded in place;
an adjustment chain (FIG. 4b-I) is threaded through the opening of the restraining plate for calculating the volume of release.
